(19) United States
(12) Patent Application Publication
(10) Pub. No.: US 2008/0081314 A9
(43) Pub. Date: Apr. 3, 2008

(54) Dental appliance and method for positioning and holding inlays and onlays during bonding and cementation process

(76) Inventor: Marc Lazare, Jericho, NY (US)

Correspondence Address: BLANK ROME LLP, 600 NEW HAMPSHIRE AVENUE, N.W., WASHINGTON, DC, 20037, US

(21) Appl. No.: 11/010,283

(22) Filed: Dec. 14, 2004

Related U.S. Application Data
(63) Continuation-in-part of application No. 10/651,375, filed on Aug. 28, 2003, now abandoned.
Application No. 10/651,375 is a continuation-in-part of application No. 10/156,451, filed on May 28, 2002, now abandoned.

(51) Int. Cl. A61C 3/00

(52) U.S. Cl. 433/163; 433/141

(57) ABSTRACT

A dental appliance that includes a handle and a head with opposite first and second ends. The first end of the head is attached to the handle. A gripper has a first end attached to the second end of the head. The gripper includes a flexible material contoured such that a second end of the gripper engages and conforms to a restoration adapted to be placed on, within or around the tooth of a patient, so that pressure applied to the gripper evenly distributes forces onto the restoration.

### FIELD OF THE INVENTION

The present invention relates to a dental appliance and a method for positioning and holding an inlay, onlay, or any indirect dental restoration, such as ceramic, porcelain, or metal dental restoration) within and around one or more surfaces of a prepared tooth. The dental appliance has at least one point of contact, either broad or narrow, allowing a dentist to adjust the position and hold an inlay or onlay within and around the prepared portion of the tooth during the bonding process. A substance may also be added to the tip, such as by being sprayed on or painted on, to enable the tip of the dental implement to stick to or hold the restoration allowing it to be carried to the tooth for its seating or insertion.

### BACKGROUND OF THE INVENTION

The materials used in placing indirect dental restorations vary, including composite resins, customized lab or machine made porcelain and metal restorations. Each dental inlay, onlay, ¾ crown, crown or veneer is individually crafted and made to fit within and/or around the prepared portion of the tooth. The materials are specially selected to match the color and translucency of natural teeth. Inlays, onlays and the like, can improve the cosmetic appearance of discolored and/or damaged teeth and can strengthen and restore shape and function to broken or decayed teeth.

The common practice during the insertion of an inlay or onlay to a tooth is for a dentist to hold the restoration in place during bonding with either his or her finger, or by using an instrument that is not specifically designed for placing this restoration, such as the back end of a dental mirror, or by having the patient close on a stick or a cotton roll. This practice has several shortcomings. For example, a typical bonding process requires the use of a light source to cure a light sensitive adhesive and cement. However, the finger of the dentist obscures the restoration, and makes it difficult to both see the restoration and to direct the light to the portion of the restoration that the dentist wants to cure.

Furthermore, the dentist may need to reposition the onlay or restoration prior to curing the adhesive material, and a single finger in a wet protective glove that may have sticky adhesive on one part and may be slippery on another part can have the tactile sensation impaired, and can slip in relation to the restoration. Slipping can cause a failure in the bonding of the restoration, for example positioning the restoration incorrectly, compromising the integrity of the margins resulting in areas of recurrent decay. Typically, force must be applied to the restoration apically, as well as towards the mesial, distal, buccal and lingual directions in different cases. Margins that are not properly sealed can require the restoration to be removed by drilling it away from the surface of the tooth, causing patient discomfort, a prolonged procedure, and replacement by a restoration.

Some dental appliances have been disclosed to replace a dentist's finger during this process. For example, the following U.S. Patents disclose various instruments that can be used to seat and/or hold an inlay, onlay or similar type of restoration in place during cementation: U.S. Pat. No. 5,040,981 to Oliva entitled “Dental Restoration Holder and Placement Tool” discloses a tool with a tip that has a tacky substance and, alternatively, thin tabs with adhesive for picking up, placing, and holding a veneer; U.S. Pat. No. 4,953,902 to Brown, entitled “Device for Adhesively Holding Small Objects” discloses a tool having a tip with a plunger that dispenses an adhesive for picking up, placing and holding a veneer; and U.S. Pat. No. 4,822,278 to Oliva et al. entitled “Dental Veneer Instrument” discloses a tool adapted for use with a vacuum source and a transparent suction tip, the subject matter of each of which is herein incorporated by reference. Nevertheless, most dentists continue to use their fingers or use an instrument that is not specifically designed for inserting this restoration to place and hold the inlay or onlay in place during bonding, because known appliances do not apply pressure evenly over the surface of the restoration and do not give sufficient pressure feedback to the dentist.

Known appliances often slip or come unbound from the restoration when a torque or force is applied to it. Dentists often are then forced to use their fingers to reposition or reseat the inlay or onlay, and then, by default, the dentist must hold that restoration with a finger while curing the adhesive cement. This often leaves excess, cured adhesive visible on the tooth that must be subsequently removed by drilling, grinding or polishing.

Appliances that adhere to a restoration by suction, adhesive or sticky wax, slip less than plastic probes without suction or adhesive, but the adherence between the appliance and the restoration can exert a negative pressure or pulling on the inlay or onlay during removal of the appliance from that restoration. Pulling on the restoration is undesirable. A pulling force during or after the bonding process can cause the inlay or onlay to de-bond or cause voids in the adhesive layer between the tooth and the restoration.

### SUMMARY OF THE INVENTION

The present invention is directed to a dental appliance and a method for positioning, holding and seating an inlay and onlay restoration using a dental appliance that gives the dentist good visibility while permitting the dentist to position, hold and seat the restoration prior to and during bonding.

In one embodiment, the dental appliance has a handle, and on one end of the handle is a head or tip (either fixed or removable) with a point of contact (either narrow or broad), as illustrated by FIGS. 1A-1E. In another embodiment the head or tip can have a plurality of points of contact, as illustrated in FIGS. 12 and 13A-13D. For example, the plurality of points of contact can comprise any number of points. Each flexible or non-flexible point can be fixedly or removably attached to a head, which can be fixedly or removably attached to the handle. Furthermore, the points of contact can be spaced apart such that the dentist can apply a positive pressure evenly over the surface of the restoration. In another embodiment of the invention, the head and points of contact alone are a replacement head for a dental appliance, as illustrated by FIGS. 2A-2E, 3A-3D, 9 and 10.

In another embodiment, the dental appliance has a handle, and on one end of the handle is a head having one point of contact. For example, the point of contact can be in any shape, such as for example, an oval, rectangle, pyramid or square, and the point of contact can be in any size, as illustrated in FIGS. 7A-7H. The head or tip itself can be in any size and shape and it can be fixedly or removably attached to a head, which can be fixedly or removably attached to the handle. Furthermore, the point of contact can be contoured and flexible such that it will fit any tooth and the dentist can thereby apply a positive pressure evenly over the surface of the restoration. The point of contact itself may be thin or broad, wide or narrow, rounded or flat, etc. In another embodiment of the invention, the tip with the point of contact (or contacts) alone is as a replacement part for a dental appliance, as illustrated by FIGS. 2A-2E.

In one embodiment of the method, the dentist places an inlay or onlay, which has previously had adhesive applied on the under side of the restoration, on a tooth in a patient's mouth. Then, the dentist uses a dental appliance with one hand, positioning the point(s) of contact of the dental appliance on the exposed surface of the restoration. Next, the dentist checks the position of the restoration and, if necessary, repositions it by applying force, such as torque and shear forces, on the restoration via point(s) of contact, ensuring that the margins are sealed. When the inlay or onlay is properly positioned, the dentist holds it in place by applying positive finger pressure on the point(s) of contact, and, if necessary, removes excess adhesive from around the margins. Then, a light source is introduced and the restoration is bonded into place.

In an embodiment of the invention the dental appliance has flexible grippers, or one flexible gripper, that limit the positive pressure applied to the restoration to a pressure range within a reasonable positive pressure. A reasonable positive pressure is in the apical direction and within a range greater than zero and less than a pressure that would cause discomfort to a patient, mar the surface of the restoration, or damage the tooth. For example, a typical range would help the dentist to limit the pressure to no greater than the pressure typically used by a dentist who is positioning and holding an inlay or onlay with a finger. More preferably, the limit of pressure can be the pressure exerted by the dental appliance by a force limited to a range greater than zero or less than one pound, wherein the force is applied by the dentist to the dental appliance.

As an embodiment of the invention, a dental appliance has one or more pads that have a soft, non-slip material in contact with the dental inlay or onlay, such that a dentist can hold and reposition the dental inlay or onlay prior to and during a bonding process without marring the surface of the dental restoration. The pad may be removable and replaceable or fixed on a gripper.

A material is soft if it is sufficiently elastic, plastic, and/or elasto-viscoplastic such that the material conforms to a surface in contact with the material without marring the surface of the material. Also, a material is considered non-slip, if the slippage across a surface of a particular material is sufficiently negligible that the material is useful for applying typical torque and shear forces to the surface of the particular restoration via the non-slip material during normal positioning of the dental restoration. As one example, a latex coating having a thickness approximately equal to a latex glove can be used on a conforming pad that will come into contact with an inlay or onlay to provide sufficient non-slip properties to the conforming pad. More preferably, the pad or tip can be made of silicone rubber or a santoprene (or similar) material for a conforming pad that will come into contact with an inlay or onlay.

As one embodiment of the invention, the method of bonding the inlay or onlay improves the quality of the bonding process, reducing the tendency for margins to be left unsealed, reducing the time for bonding the restoration to the tooth, and reducing patient discomfort.

Another embodiment of the invention has a handle where the dental appliance is double sided, such that two of the same or two different types of replicable tips may be used (that is one tip to seat the restoration, another to remove the excess cement).

One additional characteristic of the invention includes the possibility of a substance that may be added to the tip (either sprayed on, painted on, from being dipped into, etc.) to enable the tip of the dental implement to stick to or hold the restoration allowing it to be carried to the tooth for its seating or insertion.

### BRIEF DESCRIPTION OF THE FIGURES

For the purpose of illustrating the invention, representative embodiments are shown in the accompanying figures, it being understood that the invention is not intended to be limited to the precise arrangements and instrumentalities shown.

FIG. 1A-1E illustrate an embodiment of the invention, with the head of a dental appliance that can either be fixed or removable from its handle;

FIG. 2A-2E show an embodiment of the gripper or tip of the dental appliance to be used in the method of positioning and holding dental inlays and onlays during the bonding and cementation process;

FIG. 3A-3D show the dental inlay/onlay tip of FIGS. 2A-2E;

FIG. 4 is an enlarged perspective view of a portion of the handle, the head and the contact area of an embodiment of the dental appliance, and shown in relation to a dental inlay or onlay, as it is used in the method of seating the restoration during cementation;

FIG. 5 is a perspective view of an embodiment of a stiffened tubular handle having a non-circular cross section;

FIG. 6 is a partial enlarged perspective view of the gripper with a single tip, demonstrating its area of contact and its relation to the handle;

FIGS. 7A-7H show several embodiments of the tip of the dental appliance, demonstrating that the point of contact can be broad or narrow, large or small, rectangular, square, circular, oval, or triangular, and the base of the tip can be varying in shape and symmetry;

FIG. 8 is a partial perspective view of a internal hex of the tip, showing how the tip can rotate about the external hex of the handle, according to the embodiments of the invention;

FIG. 9 is a rear perspective view of an embodiment of the dental appliance tip of the invention showing the internal hex;

FIG. 10 is a front perspective view of the dental appliance tip of FIG. 9, showing one broad point of contact for the gripper;

FIG. 11 is a perspective view of the dental appliance handle, wherein the gripper has been removed from the head, and the external male hex of the tip is evident, along with the raised grip of the handle;

FIG. 12 is a partial perspective view of an embodiment of the dental appliance of the invention having multiple grippers;

FIGS. 13A-13D show an embodiment of the dental appliance of the invention wherein the plurality of grippers have been used; and

FIG. 14 is a perspective view of a possible embodiment of the handle where the dental appliance is double sided, such that two of the same or two different types of replicable tips may be used, that is one tip to seat the restoration and another to remove the excess cement.

### DETAILED DESCRIPTION OF THE PREFERRED EMBODIMENTS

The present invention will now be described in detail for specific preferred embodiments of the invention. These embodiments are intended only as illustrative examples and the invention is not to be limited thereto.

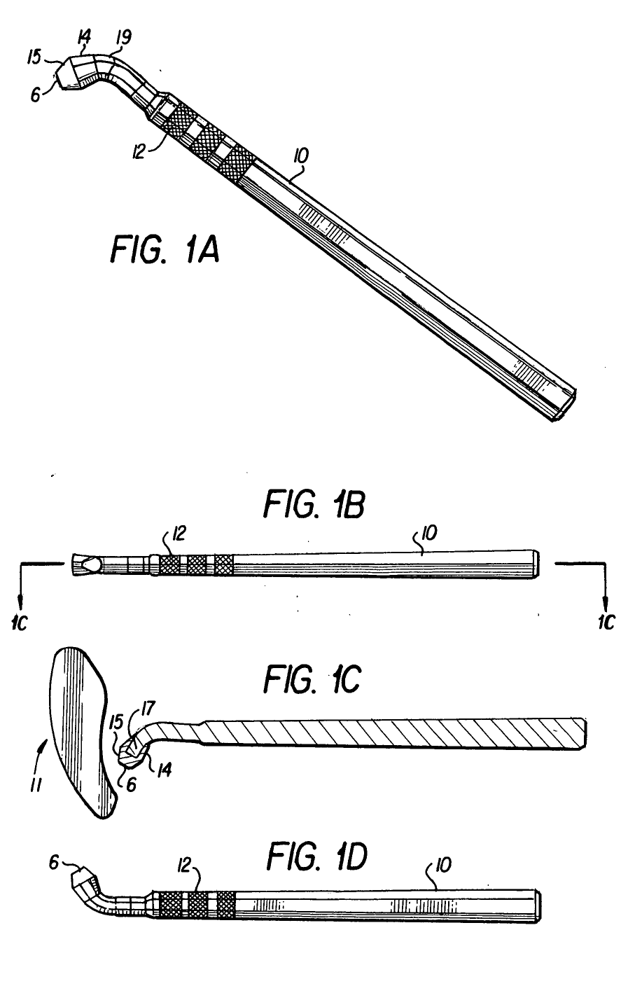

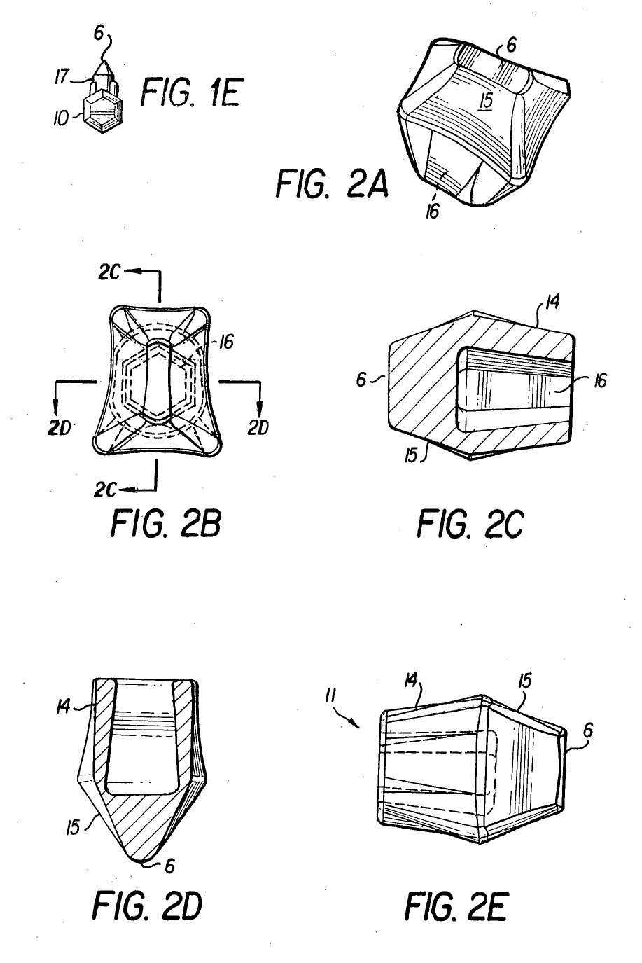

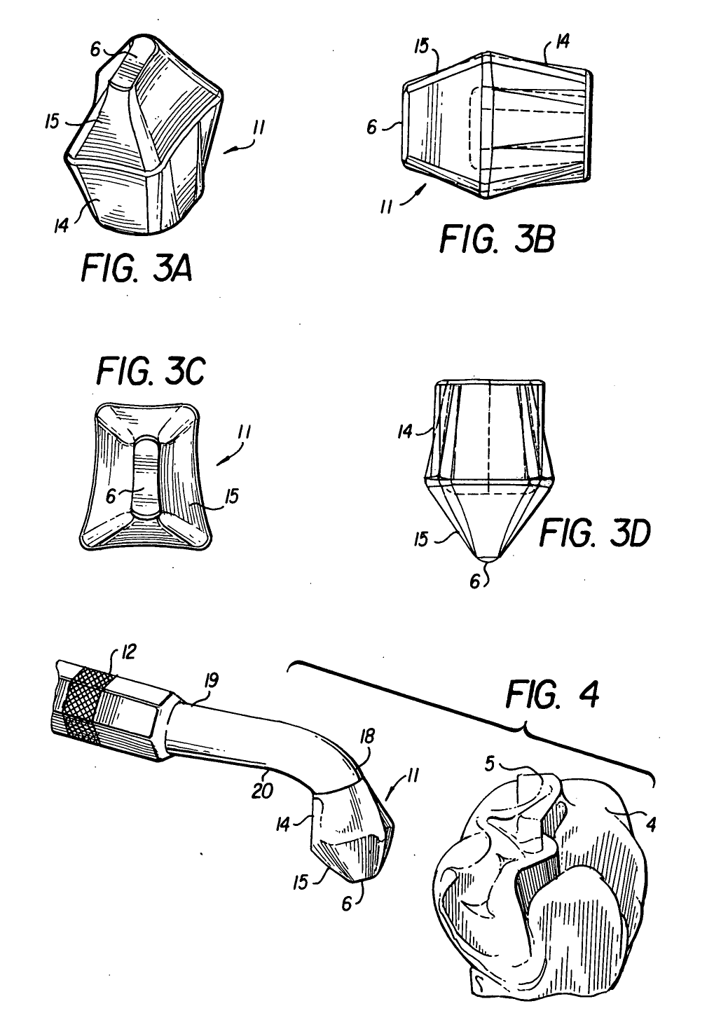

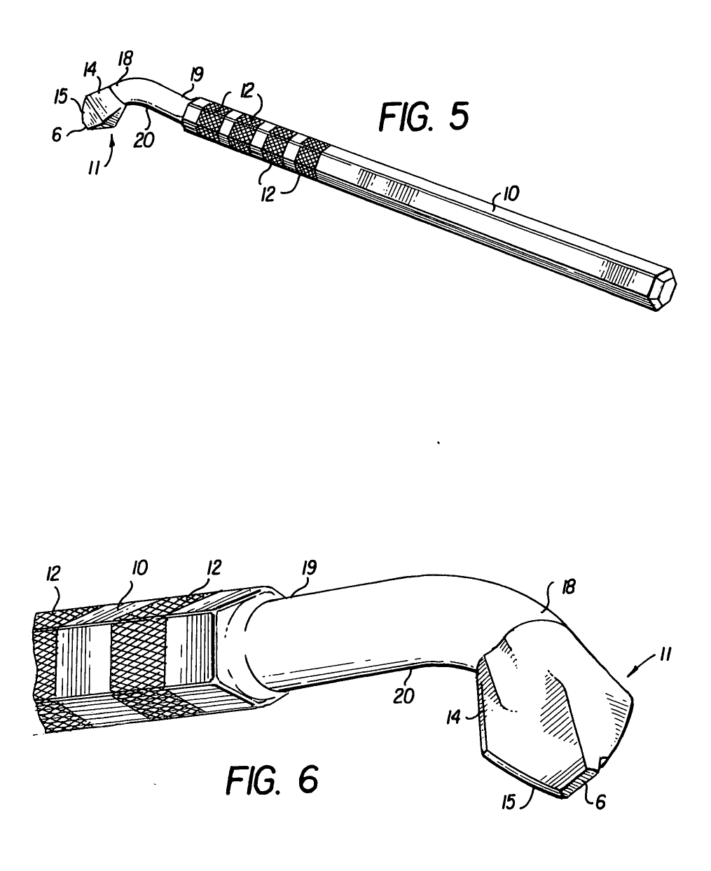

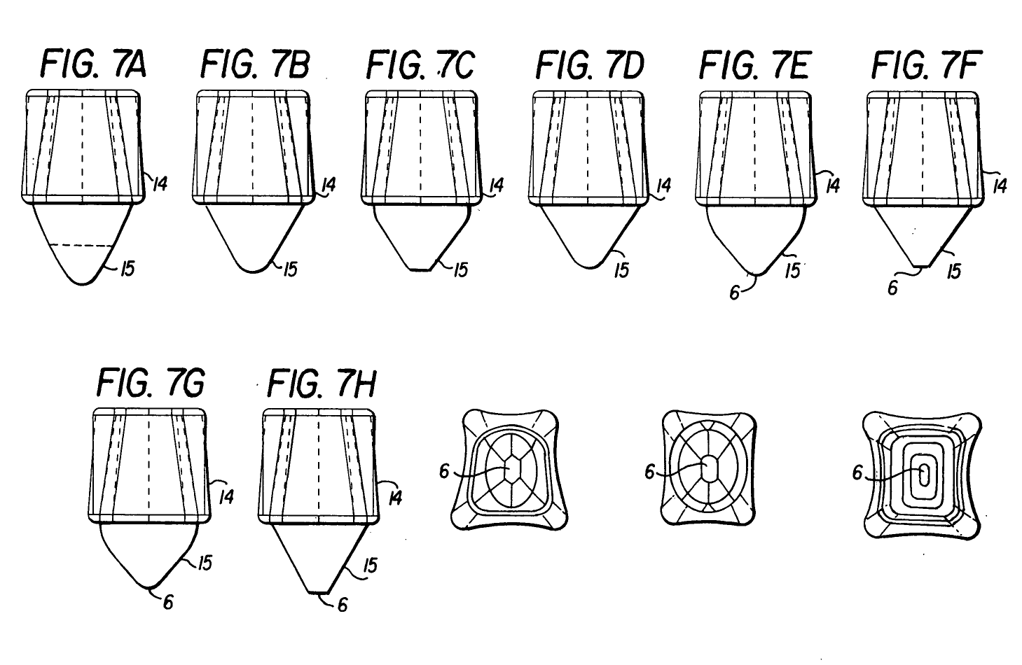

As seen in FIGS. 1A-1E and 5, a head 20 can be attached to a handle 10 that is made of a rigid material, for example an autoclavable plastic, such as vectra. Alternatively, the handle 10 can be disposable or chemically sanitizable. In yet another alternative, the handle 10 can be metal, ceramic, or a glass filled polycarbonate. The handle 10 can be solid or, more preferably, the handle 10 can be at least partially hollowed. For example, the handle 10 can be tubular. More specifically, it can be a circular tube, a tube with a square cross section, or a stiffened tubular design, for example. The handle 10 can also be hollowed by removing material from the handle, for example. The handle 10 can be a single material, or the handle 10 can be made from more than one material. For example, the handle 10 can have a soft, non-slip grip 12, where the appliance is held, to prevent slipping between the grip and the dentist's gloved hand. In one embodiment the grip 12 is textured. Furthermore, the handle 10 can be curved to give better access to the teeth at the back of the mouth. For example, the handle 10 can have a bend that allows use in the rear of the left-rear of the patient's mouth. Alternatively, the handle 10 can a have a rotatable head to reach into either the left-rear or right-rear of a patient's mouth.

One embodiment of the present invention is a replacement head for a dental appliance having a head 20, and a single gripper or point of contact 6, as seen in FIG. 5. The head 20 is attached to the handle 10 and provides a transition between the handle 10 and the tip including a first end 14 of a gripper 11, a second end 15 of a gripper 11, and the point of contact 6. The head 20 can be the same material as the handle 10 and can be seamlessly integrated with the handle 10. Alternatively, the head 20 can be a different material than the handle 10 and, for example; can be joined to the handle 10 by insertion of the head 20 into the handle 10. In one embodiment the head 20 is fixedly attached to the handle 10, for example the head 20 can be integrally molded with the handle 10 or adhesively bonded to the handle 10. In an alternative embodiment, the head 20 is removably attached to the handle 10. The head 20 can be either autoclavable or non-autoclavable, and can be reusable or disposable.

In one specific embodiment of the invention, the dental appliance comprises the handle 10, the head 20, and the gripper 11 with a single point of contact 6. This gripper 11 has its tip attached to the head, as illustrated in FIGS. 1A-1E, 4, 5, 6, and 8, for example. Although the invention in these figures encompasses a gripper with a single point of contact, the tip 11 may also have a plurality of grippers 21 (FIG. 12), including, but not limited to, one, two, three, four, five or six grippers, which can be arranged in a variety of geometric arrangements, such as diagonal; vertical; horizontal; triangular; square or rectangular; or diamond.

Each gripper or tip 11 can have a soft, non-slip contact pad for contacting the restoration without damaging the surface of the restoration. The material of the soft, non-slip pad can be a material that does not slip on the surface of the restoration, even when the restoration is wet, so long as sufficient pressure is applied by the dentist during holding or positioning of the dental restoration. For example, the material can be a flexible, elastic material, such as an elastomer or can be another material coated by an elastomer. Alternatively, the pad can be a soft plastically deformable material. In yet another alternative, the pad material is an elasto-viscoplastic material. For example, the pad material can be a silicone rubber, a butyl rubber, a chlorinated butyl rubber, a fluoroelastomer, an acrylate, a bromo butyl rubber, a transparent natural rubber, a TPE, a chloroprene rubber, an ethylene acrylic rubber, an ethylene propylene, a fluorocarbon rubber, a fluorosilicone rubber, a polymer-based putty, a styrene-butadiene rubber, a nitrile rubber, or a santoprene. In one embodiment the pad is fixedly attached to the end of a gripper. In an alternative embodiment, the pad is removably attached to the first end 14 of a gripper 11, such that it can be removed and replaced after use.

In one embodiment, the material of the gripper or tip 11 is compatible with insertion into the mouth of a patient, with a composition of the elastomer that keeps the contact soft and prevents slipping of the contact on the surface of the inlay or onlay 5, or similar dental restoration, under a reasonable positive pressure that is applied by the dentist. The disposable inlay/onlay tips are interchangeable with the veneer styx tips and fit on the same handle as the device outlined in U.S. patent application Ser. No. 10/651,375 filed Aug. 28, 2003, the subject matter of which is hereby incorporated by reference. A reasonable positive pressure is within a range of pressure from nearly zero psi to a pressure less than a pressure that would cause damage to the restoration or tooth or discomfort to the patient. More preferably, the force applied by the dentist to hold the restoration in place is greater than zero but less than one pound. More preferably still, the pressure should be about the same as the pressure applied by the finger of a dentist to hold the restoration in place, according to the current practice. One specific embodiment is a polycarbonate coated by a layer of silicone rubber that is two millimeters in thickness.

In a specific embodiment of the invention, the rearward end of the head 20 is attached or, alternatively, attachable to a handle 10. In yet another embodiment, the head 20 is integrally attached to the handle 10. For example, the handle 10 and the head 20 can be integrally formed of an autoclavable polymer resin by injection molding.

Furthermore, the head 20 and grippers 6 and/or 21 can, alternatively, be sized for different sizes of dental inlays or onlays. For example, the point of contact can be narrower or broader on the single gripper tip, or the spacing between multiple grippers 21 can be either closer or further apart to size the particular head small, medium, or large to accommodate the size of the patient's particular restoration, wherein the restoration size depends on the size of the patient's tooth and the size of the area being restored.

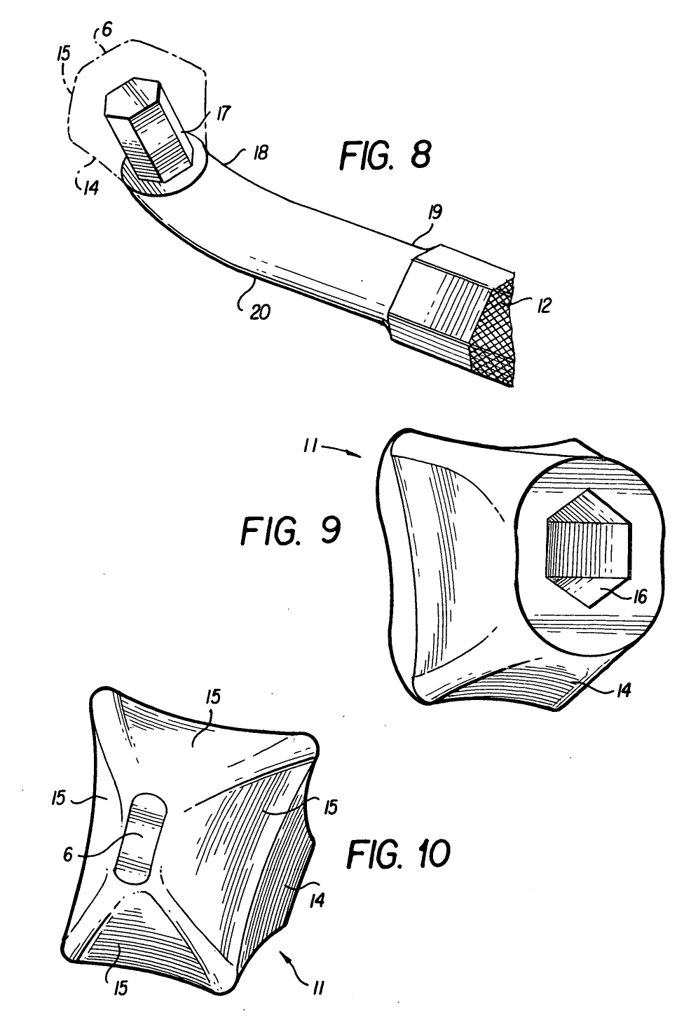

As seen in FIG. 5, the dental appliance can include a handle 10, a head 20 and a tip 11 with one gripper of point of contact 6. In this embodiment, the handle 10 is attached to a first end 19 of the head 20. The handle 10 may be fixedly or removable attached to the head 20. A second end 18 of the head 20, which contains the male coupling 17 is attached to the first end 14 of the gripper 11. The first end 14 of the gripper 11 may be fixedly or removable attached to the head 20. The tip of gripper 11 is preferably made of any pliable material, such as for example, santoprene. The second end 15 of the gripper 11, which is opposite of the head, is also contoured, such that the second end 15 of the gripper 11 may be pliably flexed in such a way to fit over or onto the tooth 4 of a patient. In this way, the second end 15 of the gripper 11 may be used to place an inlay or onlay 5 within or around a tooth 4. In FIG. 8, the gripper's point of contact 6 is in the shape of an oval, however, this second end 15 of the gripper 11 can be in any shape, including but not limited to, a square, a rectangle, circle, pyramid, triangle, trapezoid, etc.

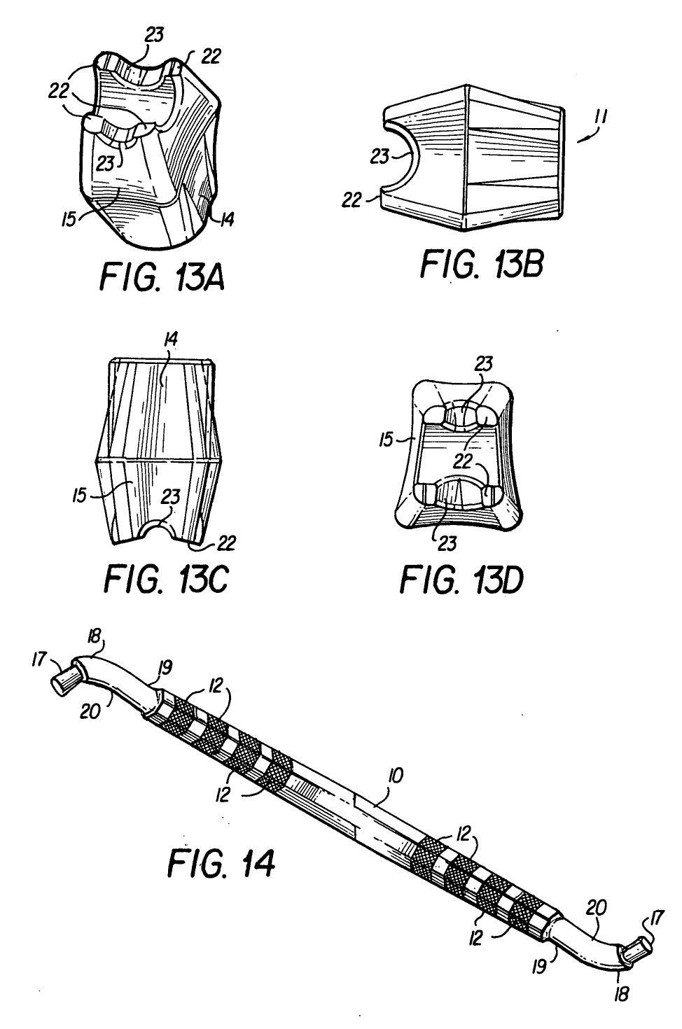

As seen in FIGS. 12 and 13A-13D, the dental appliance includes the handle 10, the head 20, and the plurality of grippers 21, wherein the plurality of grippers 21 are comprised of a single piece of pliable material. In this embodiment of the dental appliance, the handle 10 is attached to the first end 19 of the head 20. The handle 10 may be fixedly or removable attached to the head 20. The second end 8 of the head 20 is attached to the first end of the plurality of grippers 21. The plurality of grippers 21 may be fixedly or removably attached to the head 20. The plurality of grippers 21 are preferably made of a pliable material, such as for example, santoprene. As can be seen in FIG. 12, of the plurality of grippers 21 (of which there are four in a trapezoidal configuration) comprises a raised portion 22 (FIG. 13A) of the single piece of the pliable material. Preferably, portions 23 of the single piece of pliable material which are between the raised portions 22 which form the grippers are in the form of an inverted arch, which serve to stabilize and flex the raised portions 22 which form the grippers when the grippers are subject to pressures of normal use, such as for example, about one pound.

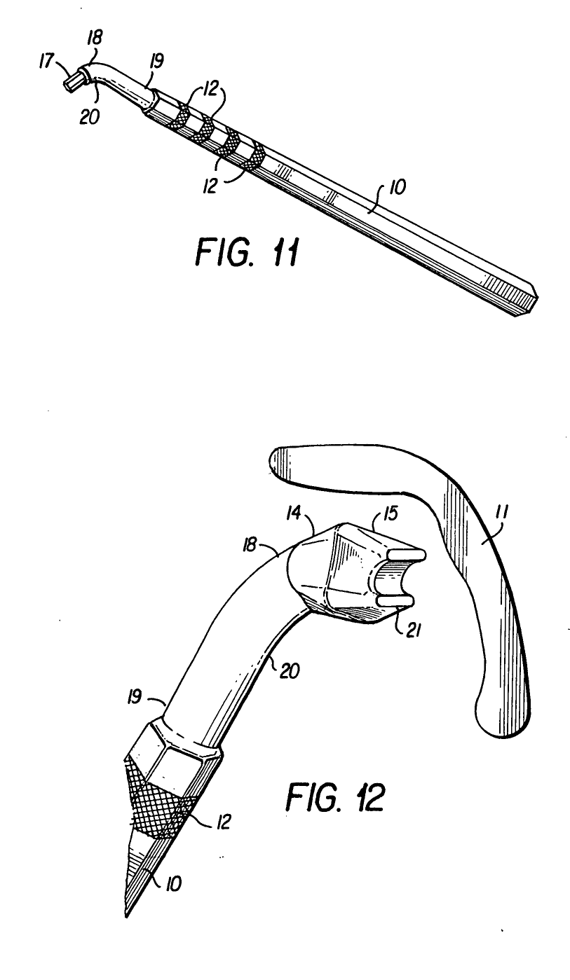

As seen in FIGS. 8 and 11, the tip 11 is removed from the head 20 or can be seen to be removed from the head. In this embodiment, the tip 11 can be removably attached to the head 20. As seen in FIGS. 8 and 11, the second end 18 of the head 20 includes the male coupling 17, while the first end 14 of the gripper 11 includes a female coupling 16 (FIG. 9). This male/female coupling can be any known male/female coupling arrangement. In the embodiment shown in FIGS. 8, 9 and 11, the male coupling 17 and the female coupling 16 are both in the form of a hexagonal design. Furthermore, in this embodiment, the female coupling 16, and thus the tip 11, may be rotatably moved around the male coupling 17, which would allow for easy positioning of the gripper's point of contact 6 for access to restorations and teeth of varying size and positions. Any embodiment of the dental appliance of the present invention, regardless of the number or type of grippers included therein, may employ such a male/female coupling arrangement for removably attaching the tip 11 to the head 20, and/or the head 20 to the handle 10.

In one preferred embodiment, the plurality of grippers 21 are spaced apart such that a light source, which is used to cure the light-curable adhesive, can access the surface of the restoration between two or more of the grippers. As seen in FIG. 13A, there is sufficient space between each of the grippers 21 for the light source to cure the adhesive between the grippers 21. This allows the dentist to cure the adhesive at two or more locations without removing and repositioning the dental appliance on the surface of the restoration.

The gripper's point of contact 6 can include a layer of a tacky substance (e.g., sticky rubber or adhesive), or contain an additive which tends to make the contact area of the gripper non-slip. More preferably, any tacky substance will cause only a negligible tensile force on the surface of the restoration when the dental appliance is removed from the surface of the dental restoration, during repositioning of the dental appliance, for example. Other embodiments are also possible, so long as the pad's point of contact 6 is elastically, plastically, and/or visco-plastically soft and non-slip on the surface of a particular restoration.

The dentist will apply, through the handle 10 of the dental appliance, a force on the dental restoration while positioning and holding the restoration during bonding. This force can be resolved into a normal component, a shear component, and a torsional component of the applied force.

The normal component of the applied force pushes (positive) or pulls (negative) in a direction perpendicular to the surface of the restoration. More preferably, the grippers 11 or 21 are made of a material that provides a negligible negative normal component of applied force. The shear component of the applied force is tangential to the surface of the restoration. The torsional force (or torque) is a twisting force that tends to cause the restoration to rotate.

The normal component of the applied force causes the second end 15 of the gripper 11 and its point of contact 6, or the plurality of grippers 21 to flex, which provides the dentist with visual and tactile feedback, allowing the dentist to limit the normal component of the applied force. In one preferred embodiment, the amount of force required to completely depress the flexible grippers, is about one pound. Therefore, the range of the normal component of force for this preferred embodiment is between zero and about one pound. The dentist can both see and feel that the maximum pressure has been reached, when the flexible grippers are completely depressed. Therefore, the dentist can avoid exceeding the preferred limit on the normal component of the force. By the term “about” one pound, the inventor suggests that the limit on the normal component of the applied force is on average one pound, but it is known that this limit will vary substantially during manufacturing of grippers and between manufacturers who are subcontracted to fabricate dental appliances, within ordinary manufacturing tolerances. Therefore, the actual limit can be greater or less than one pound, depending on manufacturing conditions, specified tolerances, and tolerances actually achieved by a particular manufacturer. Also, it is understood that, while a limit of about one pound is a preferred embodiment, other limits could be selected and are within the scope of the invention, up to a normal component of the applied force that would mar the surface of a particular restorative material, damage the patient's tooth, or cause an unacceptable level of discomfort to the patient. The preferred embodiment of about one pound was selected to limit the thickness and softness required for the soft, non-slip pads, and for the comfort of the patient.

The dental inlay or onlay 5 can be bound to the tooth 4 by curing, with a light source device, a light-sensitive adhesive that is sandwiched between a tooth and the dental restoration, using the dental appliance disclosed herein to position and hold the dental restoration. One preferred process includes the following steps. First, position the dental appliance on the surface of the inlay or onlay 5 such that the gripper's single point of contact 6, or each of the plurality of grippers 21, makes contact with the surface of the restoration. Next, a force is applied to the dental appliance, positioning the restoration in its ideal position within or around the prepared tooth, if necessary, by applying torsional and shear forces through the gripper or grippers of the dental appliance. Then, optionally, the dentist removes any excess adhesive. While holding the restoration under an applied force having at least a normal component and a shear component in the cervical direction, a light source probe is introduced to cure at least one localized area of the light-sensitive adhesive. Herein, “localized area” means a spot large enough to hold the restoration in place under its own weight and any negligible negative pressure induced by removal and repositioning of the dental appliance on the tooth. Finally, the dental appliance is removed, and the remaining uncured areas of the light-sensitive adhesive are cured.

What is claimed is:

1. A dental appliance, comprising:
a handle;
a head including opposite first and second ends, the first end of the head being attached to the handle; and
a gripper having a first end attached to the second end of the head, and the gripper including a flexible material contoured such that a second end of the gripper engages and conforms to a restoration adapted to be placed on, within or around the tooth of a patient,
whereby pressure applied to the gripper evenly distributes forces onto the restoration.

2. The dental appliance of claim 1, wherein the first end of the gripper is removably attached to the second end of the head.

3. The dental appliance of claim 1, wherein the second end of the head includes a male coupling, and the first end of the gripper includes a corresponding female coupling.

4. The dental appliance of claim 3, wherein the male coupling has a hexagonal shape, and the female coupling has a corresponding hexagonal shape.

5. The dental appliance of claim 4, wherein the gripper rotates with respect to said head.

6. The dental appliance of claim 5, wherein the flexible material is a santoprene rubber.

7. The dental appliance of claim 1, wherein the flexible material is a santoprene rubber.

8. The dental appliance of claim 1, wherein the first end of the gripper is fixedly attached to the second end of the head.

9. The dental appliance of claim 1, wherein the second end of the gripper has a shape selected from the group consisting of an oval, a rectangle, a square, a triangle, a pyramid, a circle, and a trapezoid.

10. A dental appliance, comprising:
a handle;
a head including opposite first and second ends, the first end of the head being attached to the handle; and
a gripper including a plurality of tips, wherein a first end of the gripper being attached to the second end of the head, and the gripper being a single piece of flexible material, and the plurality of tips being raised from the single piece of flexible material for gripping a dental restoration.

11. The dental appliance of claim 10, wherein the first end of the gripper is removably attached to the second end of the head.

12. The dental appliance of claim 11, wherein the second end of the head includes a male coupling, and the first end of the gripper includes a female coupling.

13. The dental appliance of claim 12, wherein the male coupling has a hexagonal shape, and the female coupling has a corresponding hexagonal design.

14. The dental appliance of claim 13, wherein the gripper rotates with respect to the head.

15. The dental appliance of claim 14, wherein the flexible material is a santoprene rubber.

16. The dental appliance of claim 10, wherein the flexible material is a santoprene rubber.

17. The dental appliance of claim 10, wherein the plurality of tips include four tips, and portions of the single piece of flexible material between the tips are in the form of an inverted arch.

18. The dental appliance of claim 17, wherein the four grippers are arranged in a trapezoidal configuration.

19. The dental appliance of claim 10, wherein the first end of the gripper is fixedly attached to the second end of the head.

20. A dental appliance, comprising:
a handle;
first and second heads each having opposite first and second ends, the first end of each head being attached to opposite ends of the handle; and
a gripper attached to the second end of each head, the gripper including at least one tip for gripping a dental restoration, and the gripper being a single piece of flexible material, and the tip being raised from the single piece of flexible material.

21. The dental appliance of claim 20, wherein the tip includes an absorbent material for removing excess bonding material.

22. A method of seating, cementing and bonding a restoration within or around a tooth with a light source probe, and using a light-sensitive adhesive that is sandwiched between a tooth and the dental restoration, using a dental appliance, comprising the steps of:
positioning the dental appliance on the surface of the restoration, wherein a gripper of the dental appliance engages the surface of the restoration;
positioning the restoration on the tooth to seal all of the margins between the dental restoration and the tooth by applying torsional, shear, and light pressure forces through the gripper of the dental appliance; and
adhering the dental restoration to the tooth by holding the restoration in place by holding the restoration in place by applying a force to the restoration using the dental appliance, wherein the applied force has at least a normal component and a shear component in the cervical or apical direction, introducing a light source probe, curing at least one localized area of the light-sensitive adhesive, positioning the dental restoration using the dental appliance, curing at least one additional localized area, and removing the dental appliance, whereby the remaining uncured areas of the light-sensitive adhesive can be cured.

23. The method of claim 22, further comprising the step of adding a substance to a tip of the dental appliance to enable the tip to stick to the restoration allowing it to be carried to the tooth.

24. The method of claim 23, further comprising the step of:
spraying, painting, or dipping the substance onto the tip.

25. The method of claim 22, further comprising the step of:
removing any excess adhesive or cement while holding the dental restoration in place with the dental appliance.
